(19) United States
(12) Patent Application Publication
(10) Pub. No.: US 2025/0201214 A1
(43) Pub. Date: Jun. 19, 2025

(54) PYROTECHNIC SPECIAL EFFECTS DEVICE FOR SAXOPHONE

(71) Applicant: Andrii Gedzyk, Vaughan (CA)

(72) Inventor: Andrii Gedzyk, Vaughan (CA)

(21) Appl. No.: 18/541,540

(22) Filed: Dec. 15, 2023

(51) Int. Cl. G10D 9/00; G10D 7/00

(52) U.S. Cl. CPC G10D 9/00; G10D 7/00

(57) ABSTRACT

The present specification discloses a saxophone device designed to enhance musical performances through captivating pyrotechnic special effects. The device integrates with the saxophone, featuring a detachable configuration for convenient attachment and removal. It comprises a rigid frame housing a battery, a switch button, a battery charging module, and holders for a combustible substance cylinder. This cylinder connects to an emitter device containing a tube, flange with detachable connections, elastic plates, and a high-voltage transformer. The transformer connects to an electric spark activation button, igniting the combustible substance for visual effects. A lever, linked to adjusting levers, controls the cylinder's valve, allowing precise regulation of the pyrotechnic effects' intensity during musical performances.

### FIELD

The field of the invention relates musical wind instruments, particularly saxophones, and to a device for creating controlled pyrotechnic special effects during saxophone performances.

### BACKGROUND

Traditional saxophones, while celebrated for their musicality, have lacked the ability to incorporate captivating visual elements into performances. Musicians sometimes attach simple LED or other lights to these instruments for visual effects. Although a saxophone with LED lights provides a futuristic look, it may not match the excitement generated by fire. Existing wind instruments offered limited scope for integrating pyrotechnic effects, restricting musicians' capacity to enhance their shows with engaging visual displays.

Prior solutions in the realm of wind instruments have explored mechanisms for providing pyrotechnic special effects. For example, some devices designed for trumpets have attempted to introduce pyrotechnic special effects (e.g. U.S. Pat. No. 4,247,283 to Vidas). However, these prior attempts were subject to significant drawbacks, such as the constant presence of a flame. This prior approach compromised safety, limiting the suitability for musical performances.

There is a need for a device that empowers saxophonists to create controlled pyrotechnic effects during their performances to elevate the visual impact of the saxophone while ensuring safety and reliability.

### BRIEF DESCRIPTION OF THE DRAWINGS

The accompanying drawings, which are incorporated into and constitute a part of this patent specification, illustrate a preferred embodiment of the invention and, together with the description, serve to explain the principles of the invention.

In these drawings:

FIG. 1 is a side view of a saxophone for use with a device according to a preferred embodiment of the present invention.

FIG. 2 is an enlarged side view of the saxophone of FIG. 1 equipped with the device according to a preferred embodiment of the present invention.

FIGS. 3a and 3b are front and rear side perspective views of a frame of the device of FIG. 2, respectively.

FIG. 4 is a perspective view of device in the form of an emitter of the device of FIG. 2, which is inserted into the saxophone's horn.

FIG. 5 is an enlarged perspective view of the saxophone of FIG. 1 equipped with the device of FIG. 2.

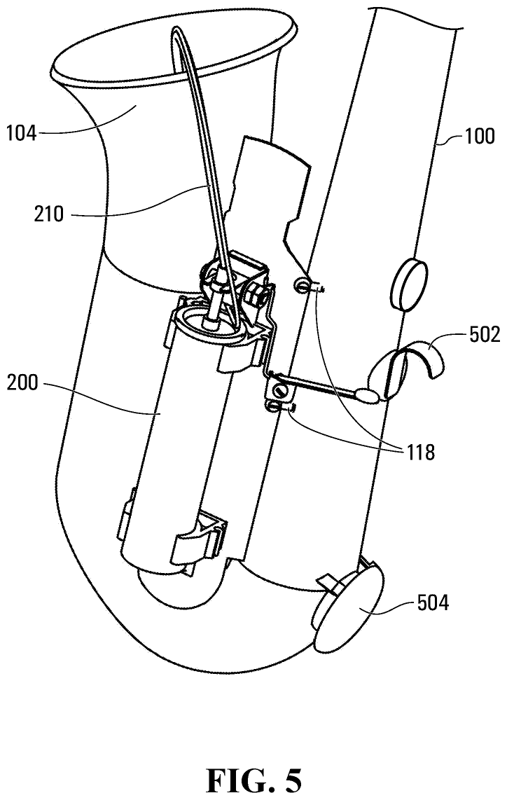

These drawings are intended to provide a visual understanding of the invention's structural elements and their interactions.

### DETAILED DESCRIPTION

Referring to the accompanying drawings, where like reference numerals denote corresponding elements throughout the specification:

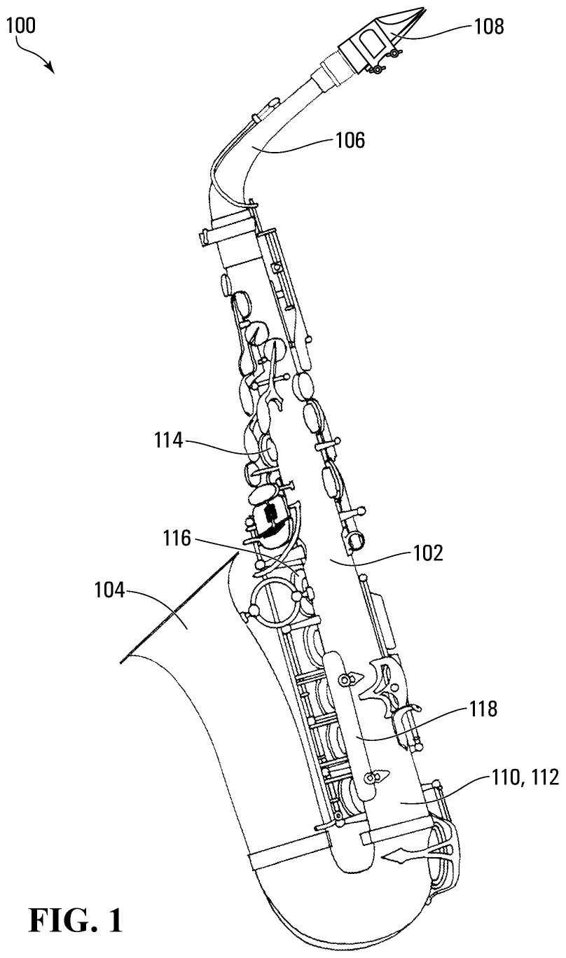

FIG. 1 provides a side view of a saxophone, identified by reference numeral 100, designed for use with an embodiment of the device of the present invention. The saxophone's construction includes a main frame 102, characterized by its curved shape, culminating with a bell 104. The main frame 102 further incorporates a neck 106, a mouthpiece 108, a central channel 110, a peripheral wall 112, openings 114, and valves 116. Notably, the saxophone features a detachable connection 118. This allows the device to be easily attached or removed, providing musicians with the choice to incorporate or omit the pyrotechnic effects as needed, enhancing the instrument's adaptability for various performance scenarios. According to some alternative embodiments, the device 200 (described below) need not be detachable, and instead can be integral with (e.g., permanently fastened to) the saxophone 100 or, in other embodiments, can be separate from the saxophone 100.

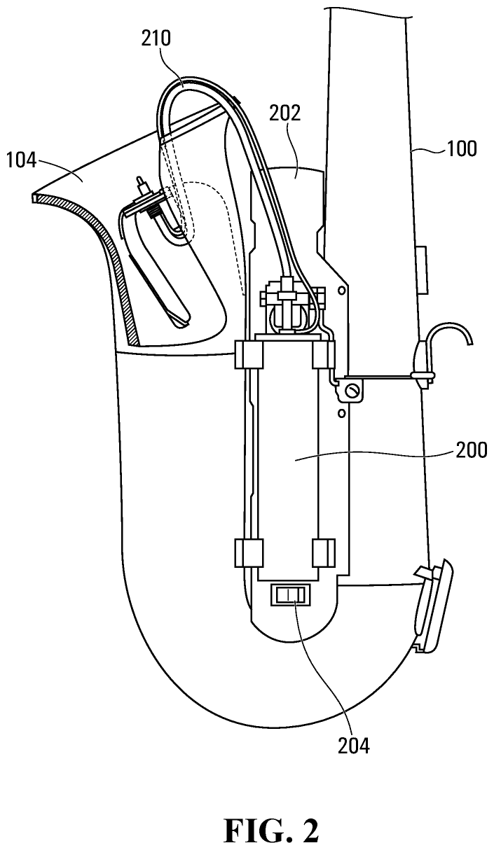

FIG. 2 presents an enlarged side view of the saxophone depicted in FIG. 1, showing a preferred embodiment of the device of the present invention. The device, denoted as 200, encompasses a rigid frame 202 housing components of the invention. The switch button 204 functions as the primary power control. When in the ON position, pressing the activation valve triggers the fire mechanism. Conversely, if the Switch Button 204 is in the OFF position, pressing the activation valve will not activate the fire mechanism. This button serves as the essential control interface for initiating the sequence necessary to generate controlled fire effects.

Still with reference to FIG. 2, a holder 206 securely positions and supports the cylinder 208. The cylinder 208 houses a combustible substance for creating the fire effect. When activated, it releases this substance through a tube 210, which acts as a conduit to the emitter device 400. Controlling the release is the valve 212, which opens and closes to regulate the flow, ensuring a controlled dispersion of the combustible substance. A lever 214, when manipulated or pressed, serves as a manual control element, setting the process into motion. Adjusting levers 216, 218 are connected to the valve 212 and allow for fine-tuning the flow, enabling the musician to control the intensity of the fire effect. The button 220 activates an electric spark, which ignites the combustible substance, initiating the visual spectacle. Powering these processes is the battery 222, while a module 224 manages the battery's charging, ensuring it remains ready for use, typically via a USB connection. Together, these components create a captivating pyrotechnic special effects during saxophone performances, offering a dynamic visual element to musical presentations. Advantageously, the device 200 can activate a small spark and opens a cylinder 208 simultaneously. The device can be used with or without a saxophone. Moreover, the pyrotechnic effect or fire can be synchronized to the music beat, allowing precise control over flame intensity from low to high.

Use of the term “combustible substance” refers to a specially formulated pyrotechnic composition or mixture. This composition is engineered for safe ignition and controlled combustion when exposed to an ignition source. It encompasses the use of basic camping gas canisters, such as propane and butane, and extends to the inclusion of any pressurized flammable fuel suitable for these canisters. Additionally, the formulation includes a range of fuel mixtures that have been developed to create diverse flame colours, including green, red, and blue. This pyrotechnic composition is specifically designed to produce controlled, visually striking flames or pyrotechnic effects, which significantly enhance the visual experience of musical performances.

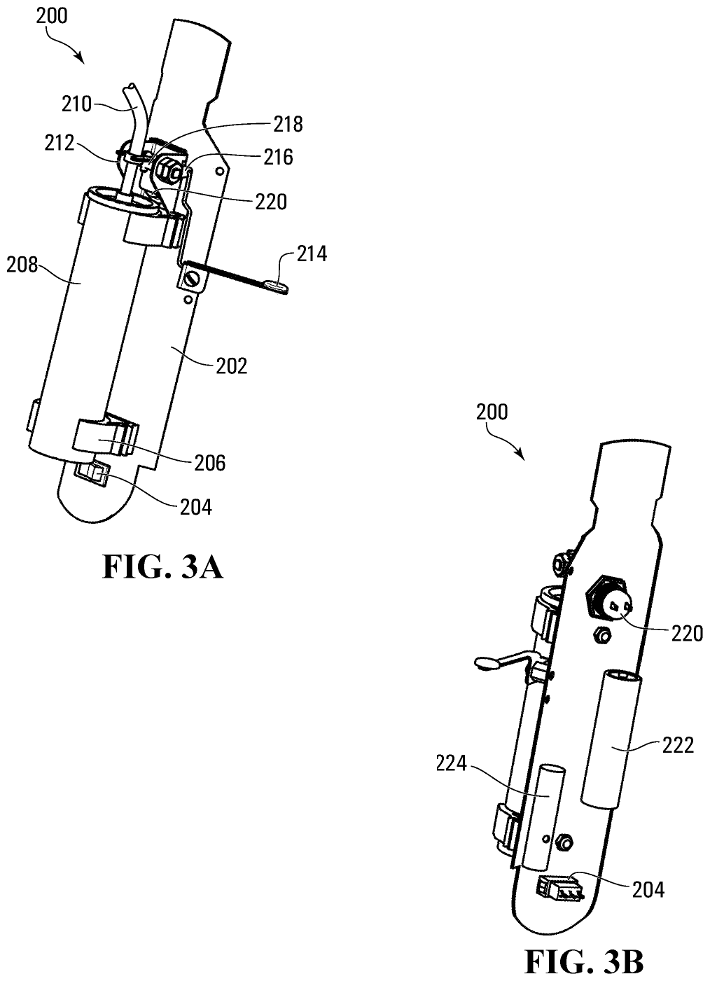

FIGS. 3a and 3b provide front and rear side perspective views of a frame of the device illustrated in FIG. 2, respectively. These views showcase the structural details of the frame, highlighting its key components and their arrangement.

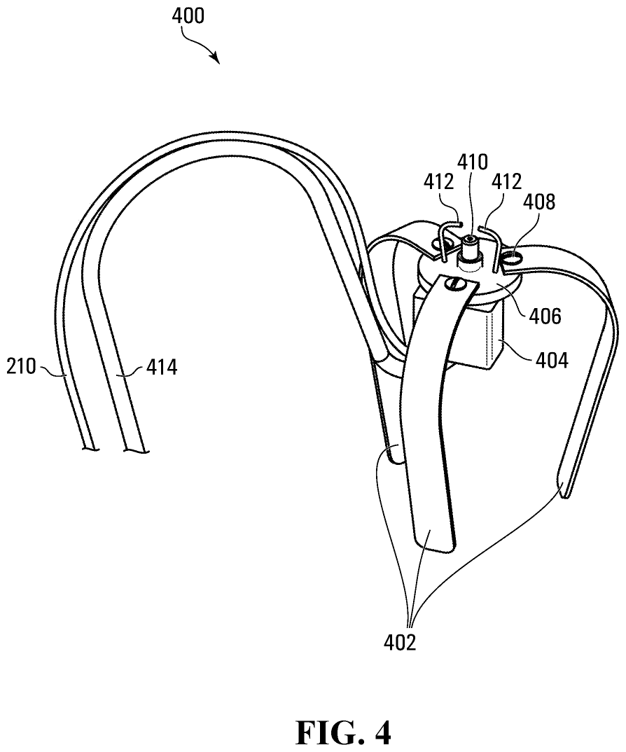

FIG. 4 offers a perspective view of the device referred to as an “emitter” or “spider”, which is inserted into the saxophone's horn. This emitter, identified as 400, comprises curved plastic plates 402, a high-voltage transformer 404, a flange 406, and detachable connections 408. The tube end 410 and the cable end 412 play a pivotal role in the device's operation. Furthermore, a cable 414 establishes essential connections between various components.

Advantageously, use of the device 200 enables the generation of captivating pyrotechnic special effects during saxophone performances. As the musician plays the saxophone, pressing down on lever 214 initiates a chain reaction. This action activates levers 216 and 218, which, in turn, engage the cylinder valve 212 and the electric spark activation button 220 simultaneously. From the cylinder 208, a combustible substance is released, and upon activation of button 220, an electric spark is created, resulting in a visually stunning display of controlled fire effects.

This device 200 attaches to the back side of the main frame 102 of the saxophone via detachable connection 118. The force applied to lever 214 regulates the variety and intensity of the visual special effect, providing a dynamic element to saxophone performances.

Use of the device 200 enables the saxophone to be used traditionally or, when desired, to produce captivating visual special effects, such as the controlled appearance of fire from the horn, enhancing the quality and entertainment value of musical presentations. The design is both simple and reliable, ensuring ease of use, safety, and broad applicability within the field of wind instruments.

Furthermore, the device's versatility extends to accommodating a range of enhancements, such as the incorporation of a radio receiver for a microphone on the frame, enabling musicians to integrate wireless audio technology into their performances while simultaneously employing the pyrotechnic special effects. Additionally, the device's adaptability extends to remote control functionality and integration with lighting systems to create dynamic and immersive musical presentations.

The present invention offers several distinct advantages. Firstly, it eliminates the need for a pilot light, thus enhancing safety by reducing the risk of unintended ignition. Moreover, the invention ensures a controllable and constant source of fire, eliminating the challenges associated with managing gas flow and combustion consistency in traditional systems. According to one embodiment, the device operates through a manual valve press, which mechanically opens gas valves without requiring batteries or external power. This design improvement contrasts with the initial model, which used a 220V power button and a bulky mechanism to open the gas bottle. This allows for automatic ignition, making it highly convenient for musicians during performances. Notably, the use of a USB battery in the device enhances its portability, making it more versatile and suitable for various performance settings. This innovative approach enhances the quality of presentations while mitigating safety concerns and simplifying operation, rendering it an advantageous solution within the field of musical wind instruments.

The foregoing description of the invention, including its various components, their arrangement, and the advantages offered, is provided for illustrative purposes and is not intended to be exhaustive or limiting. It is understood that numerous modifications, variations, and alterations may be made to the invention by those skilled in the art without departing from the scope and spirit of the invention. Therefore, the scope of the present invention should be determined by the appended claims and their legal equivalents, rather than by the examples given.

1. A saxophone device for generating pyrotechnic special effects during musical performances, comprising:
a saxophone comprising a main frame of a curved shape, terminating in a bell, and a neck with a mouthpiece, said main frame having at least one central channel, said channel having openings and a system of valves connecting said channel to surrounding air; and
a detachable device comprising:
a rigid frame equipped with a battery for power, a switch button, a battery charging module, and a fixed holder for a cylinder containing a combustible substance; wherein the cylinder is linked via a detachable tube to an emitter device featuring a tube, a flange with detachable connections, a plurality of curved plastic plates, and a high-voltage transformer installed on said tube, said transformer being connected by a cable to an electric spark activation button and supplying an electric spark above the free opening of said tube; and
a lever linked by adjusting levers to a valve controlling the opening of the cylinder, and said lever actuating said electric spark activation button; wherein said device is detachably affixed to the back side of said main frame of the saxophone via a detachable connection, and said lever controls the variety and intensity of the pyrotechnic special effects generated during musical performances.

2. The saxophone device of claim 1, wherein the detachable device further comprises a radio receiver for a microphone, allowing for integration of wireless audio technology into musical performances while employing pyrotechnic special effects.
